(19) United States
(12) Patent Application Publication
(10) Pub. No.: US 2007/0242876 A1
(43) Pub. Date: Oct. 18, 2007

(54) Image Processing Apparatus, Image Processing Method, and Program

(76) Inventors: Kohtaro Sabe, Tokyo (JP); Jun Yokono, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/697,203

(22) Filed: Apr. 5, 2007

(30) Foreign Application Priority Data
Apr. 6, 2006 (JP) 2006-105391

(51) Int. Cl. G06K 9/00

(52) U.S. Cl. 382/165

(57) ABSTRACT

The present invention provides an image processing apparatus to recognize a predetermined model whose surface has a plurality of colors from an input color image that is obtained by capturing an image of a color object whose surface has a plurality of colors. The image processing apparatus includes a detecting unit configured to detect color areas from the input color image, each color area including adjoining pixels of the same color; and a recognizing unit configured to determine whether the color areas on the input color image detected by the detecting unit correspond to parts of the model to which color areas on a reference color image obtained by capturing an image of the model correspond, and determine whether the color object in the input color image is the model on the basis of the determination result.

### CROSS REFERENCES TO RELATED APPLICATIONS

The present invention contains subject matter related to Japanese Patent Application JP 2006-105391 filed in the Japanese Patent Office on Apr. 6, 2006, the entire contents of which are incorporated herein by reference.

### BACKGROUND OF THE INVENTION

1. Field of the Invention

The present invention relates to an image processing apparatus, an image processing method, and a program. Particularly, the present invention relates to an image processing apparatus, an image processing method, and a program, capable of appropriately recognizing a model by determining whether a subject in an input image is the model on the basis of the position relationship between color areas of the model on an image and color areas of the model on the input image.

2. Description of the Related Art

Object recognition using a color image is often used for a robot visual system or the like because of its simple and quick process and easy recognition regardless of the size of an object (or distance to the object) and change in visibility.

A method for extracting a color from a color image is described in Patent Document 1 (Japanese Unexamined Patent Application Publication No. 11-72387). A method for recognizing a color image is described in Patent Document 2 (Japanese Unexamined Patent Application Publication No. 08-16778).

### SUMMARY OF THE INVENTION

However, in a case where an object of a specific single color is to be recognized, false recognition occurs if the background has the same color as that of the object. That is, if the background of the object to be recognized can have various colors, it may be impossible to appropriately recognize the object.

Also, since an object can be recognized only if it has a defined color, the number of recognizable objects is limited.

Under these circumstances, there is suggested a method for recognizing an object by using the similarity of feature amounts and constraint of position relationship between the feature amounts, focusing attention on local feature amounts of the object.

In this method, local feature amounts at all interesting points in an image are obtained, all of local feature amounts similar to the local feature amounts of a registered object are extracted as candidate pairs, and parameters to transform their position relationship are voted for in the space (Hough transform). If a transform parameter obtained many votes exists, it is determined whether the registered object exists in an input image at the position or attitude indicated by the transform parameter.

In this way, the object can be stably recognized regardless of its background on the basis of pairs including constraint of positions of a plurality of characteristic textures.

In this method, however, matching is performed by using many local feature amounts, which takes much time. Also, since texture itself on a feature point changes depending on the size or visibility, it may be impossible to appropriately recognize an object in some viewing directions.

The present invention has been made in view of these circumstances and is directed to realizing easy and appropriate recognition of a color object.

According to an embodiment of the present invention, there is provided an image processing apparatus to recognize a predetermined model whose surface has a plurality of colors from an input color image that is obtained by capturing an image of a color object whose surface has a plurality of colors. The image processing apparatus includes detecting means for detecting color areas from the input color image, each color area including adjoining pixels of the same color; and recognizing means for determining whether the color areas on the input color image detected by the detecting means correspond to parts of the model to which color areas on a reference color image obtained by capturing an image of the model correspond, and determining whether the color object in the input color image is the model on the basis of the determination result.

The recognizing means may detect pairs of color area on the reference color image and color area on the input color image that can correspond to the same part of the model, determine whether the number of the pairs of color area on the reference color image and color area on the input color image that can be transformed in attitude by the same attitude parameter is a predetermined number or more, and determine whether the color object in the input color image is the model on the basis of the determination result.

The attitude parameter may be a rotation matrix or translation.

The predetermined number may correspond to the number of color areas on the reference color image.

The recognizing means may detect the position of the color object in the input color image on the basis of the attitude parameter after determining that the color object in the input color image is the model.

The recognizing means may regard the color area on the reference color image and the color area on the input color image having the same color or a predetermined difference in aspect ratio as the pair that can correspond to the same part of the model.

The recognizing means may perform vote for an attitude space of transform parameters used in attitude transform between the color area on the reference color image and the color area on the input color image in each of the pairs, determine whether the number of the pairs in which attitude transform between the color area on the reference color image and the color area on the input color image can be performed with the transform parameter corresponding to the largest votes is a predetermined number or more, and determine whether the color object in the input color image is the model on the basis of the determination result.

According to an embodiment of the present invention, there is provided an image processing method for recognizing a predetermined model whose surface has a plurality of colors from an input color image that is obtained by capturing an image of a color object whose surface has a plurality of colors. The image processing method includes the steps of detecting color areas from the input color image, each color area including adjoining pixels of the same color; and determining whether the color areas on the input color image detected in the detecting step correspond to parts of the model to which color areas on a reference color image obtained by capturing an image of the model correspond, and determining whether the color object in the input color image is the model on the basis of the determination result.

According to an embodiment of the present invention, there is provided a program allowing a computer to execute image processing of recognizing a predetermined model whose surface has a plurality of colors from an input color image that is obtained by capturing an image of a color object whose surface has a plurality of colors. The program includes the steps of detecting color areas from the input color image, each color area including adjoining pixels of the same color; and determining whether the color areas on the input color image detected in the detecting step correspond to parts of the model to which color areas on a reference color image obtained by capturing an image of the model correspond, and determining whether the color object in the input color image is the model on the basis of the determination result.

In the above-described image processing apparatus, image processing method, or program, image processing of recognizing a predetermined model whose surface has a plurality of colors is performed. Color areas, each including adjoining pixels of the same color, are detected from an input color image obtained by capturing an image of a color object whose surface has a plurality of colors. It is determined whether the detected color areas on the input color image correspond to parts of the model to which color areas on a reference color image obtained by capturing an image of the model correspond. Then, it is determined whether the color object in the input color image is the model on the basis of the determination result.

Accordingly, the model can be appropriately recognized.

### BRIEF DESCRIPTION OF THE DRAWINGS

FIG. 1 is a block diagram showing an example of a configuration of an image processing apparatus according to an embodiment of the present invention;

FIG. 2 is a block diagram showing an example of a configuration of an image processing unit 7 shown in FIG. 1;

FIG. 3 shows an example of a color table stored in a storage unit 21 shown in FIG. 2;

FIGS. 4A and 4B illustrate a method for specifying a color in the color table shown in FIG. 3;

FIG. 5 is a flowchart illustrating a color extracting process;

FIG. 6 shows a specific example of the color extracting process;

FIG. 7 is a flowchart illustrating a color area detecting process;

FIG. 8 is a flowchart illustrating a merge process in step S12 shown in FIG. 7;

FIG. 9 shows pixels compared with a target pixel in the merge process shown in FIG. 8;

FIG. 10 shows a specific example of the color area detecting process;

FIGS. 11A and 11B show another specific example of the color area detecting process;

FIGS. 12A and 12B illustrate a reference image;

FIG. 13 shows an example of model information;

FIG. 14 is a flowchart illustrating a matching process;

FIG. 15 illustrates a method for calculating an aspect ratio;

FIG. 16 shows a specific example of the matching process;

FIG. 17 illustrates the principle of a recognizing process;

FIG. 18 is a flowchart illustrating the recognizing process;

FIG. 19 shows an example of overlapping candidate pairs;

FIG. 20 is a flowchart illustrating selection in step S80 shown in FIG. 18;

FIGS. 21A and 21B show a specific example of the recognizing process;

FIG. 22 illustrates an object image area used in zooming;

FIG. 23 illustrates a zoom out process;

FIG. 24 illustrates a zoom in process; and

FIG. 25 is a block diagram showing an example of a configuration of a personal computer.

### DESCRIPTION OF THE PREFERRED EMBODIMENTS

Before describing embodiments of the present invention, the correspondence between the features of the claims and the specific elements in the embodiments described in the specification or drawings is discussed below. This description is intended to assure that the embodiments supporting the present invention are described in this specification or drawings. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

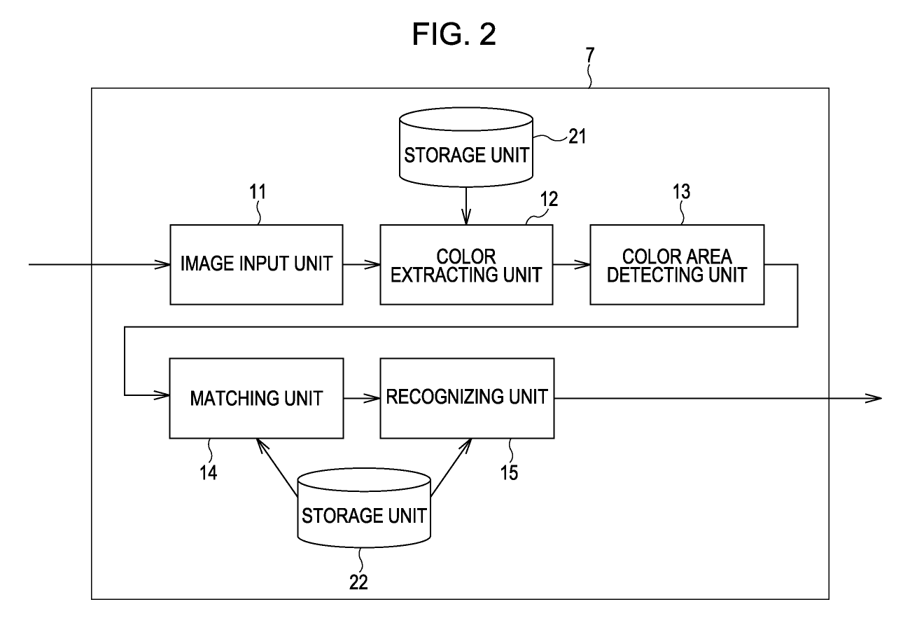

An image processing apparatus according to an embodiment of the present invention recognizes a predetermined model whose surface has a plurality of colors from an input color image that is obtained by capturing an image of a color object whose surface has a plurality of colors. The image processing apparatus includes detecting means (e.g., a color area detecting unit 13 shown in FIG. 2) for detecting color areas from the input color image, each color area including adjoining pixels of the same color; and recognizing means (e.g., a recognizing unit 15 shown in FIG. 2) for determining whether the color areas on the input color image detected by the detecting means correspond to parts of the model to which color areas on a reference color image obtained by capturing an image of the model correspond, and determining whether the color object in the input color image is the model on the basis of the determination result.

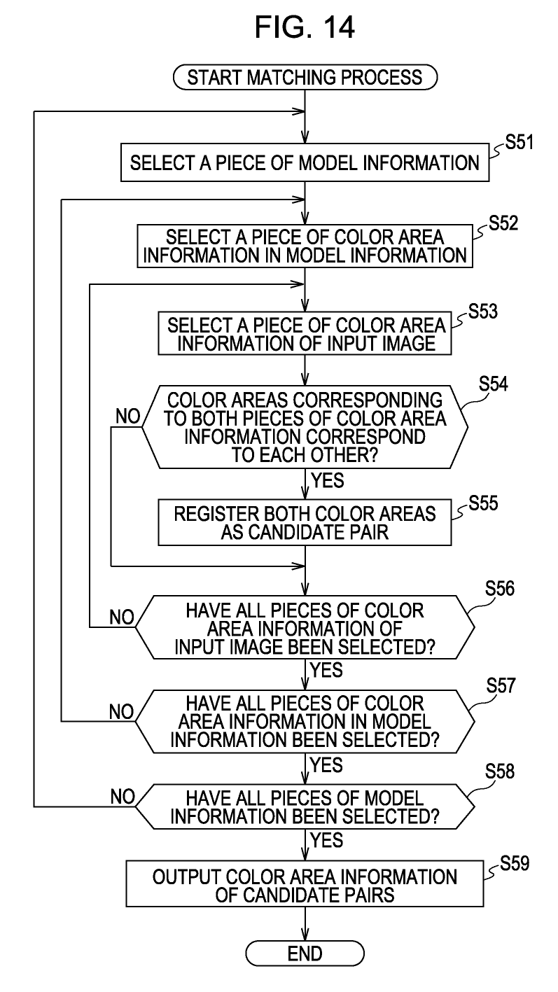

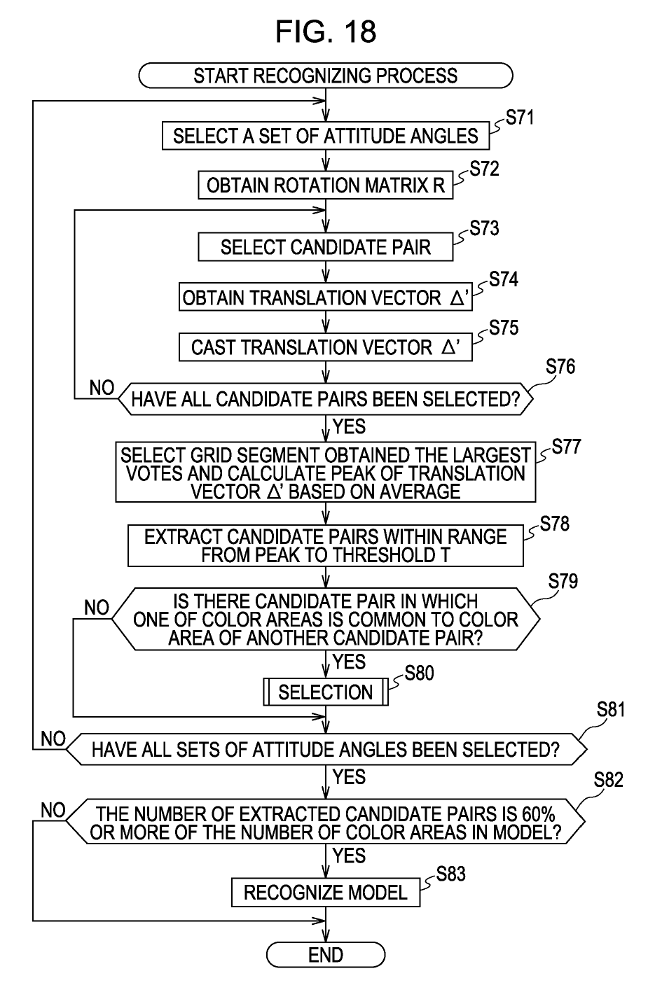

The recognizing means detects pairs of color area on the reference color image and color area on the input color image that can correspond to the same part of the model (e.g., a matching process shown in FIG. 14 performed in a matching unit 14 shown in FIG. 2), determines whether the number of the pairs of color area on the reference color image and color area on the input color image that can be transformed in attitude by the same attitude parameter is a predetermined number or more, and determines whether the color object in the input color image is the model on the basis of the determination result (e.g., a recognizing process shown in FIG. 18 performed by the recognizing unit 15 shown in FIG. 2).

The attitude parameter may be a rotation matrix (e.g., expression (6)) or translation (e.g., expression (7)).

The predetermined number may correspond to the number of color areas on the reference color image (e.g., 60% or more of the number of color areas) (step S82 shown in FIG. 18).

The recognizing means may detect the position of the color object in the input color image on the basis of the attitude parameter after determining that the color object in the input color image is the model (e.g., a position detecting process in the recognizing unit 15 shown in FIG. 2).

The recognizing means may regard the color area on the reference color image and the color area on the input color image having the same color or a predetermined difference in aspect ratio as the pair that can correspond to the same part of the model (e.g., step S54 shown in FIG. 14).

The recognizing means may perform vote for an attitude space of transform parameters used in attitude transform between the color area on the reference color image and the color area on the input color image in each of the pairs, determine whether the number of the pairs in which attitude transform between the color area on the reference color image and the color area on the input color image can be performed with the transform parameter corresponding to the largest votes is a predetermined number or more, and determine whether the color object in the input color image is the model on the basis of the determination result (e.g., steps S75 to S82 shown in FIG. 18).

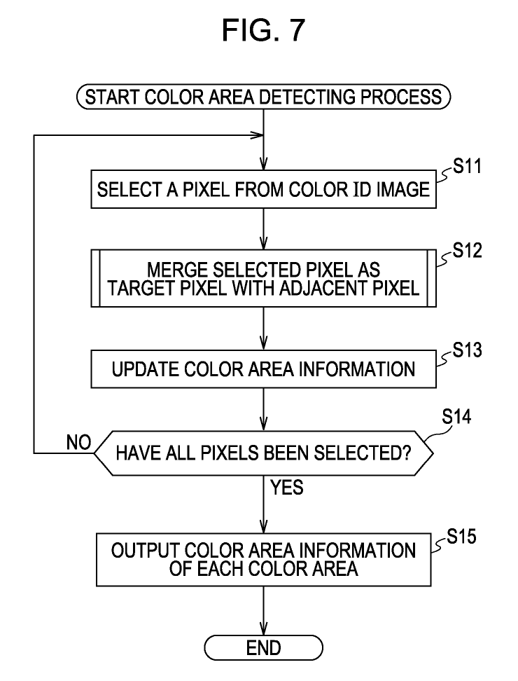

An image processing method or a program according to an embodiment to the present invention is an image processing method for recognizing a predetermined model whose surface has a plurality of colors from an input color image that is obtained by capturing an image of a color object whose surface has a plurality of colors, or a program allowing a computer to execute image processing of recognizing a predetermined model whose surface has a plurality of colors from an input color image that is obtained by capturing an image of a color object whose surface has a plurality of colors. The image processing method or the program includes the steps of detecting color areas from the input color image, each color area including adjoining pixels of the same color (e.g., the flowchart shown in FIG. 7); and determining whether the color areas on the input color image detected in the detecting step correspond to parts of the model to which color areas on a reference color image obtained by capturing an image of the model correspond, and determining whether the color object in the input color image is the model on the basis of the determination result (e.g., the flowchart shown in FIG. 18).

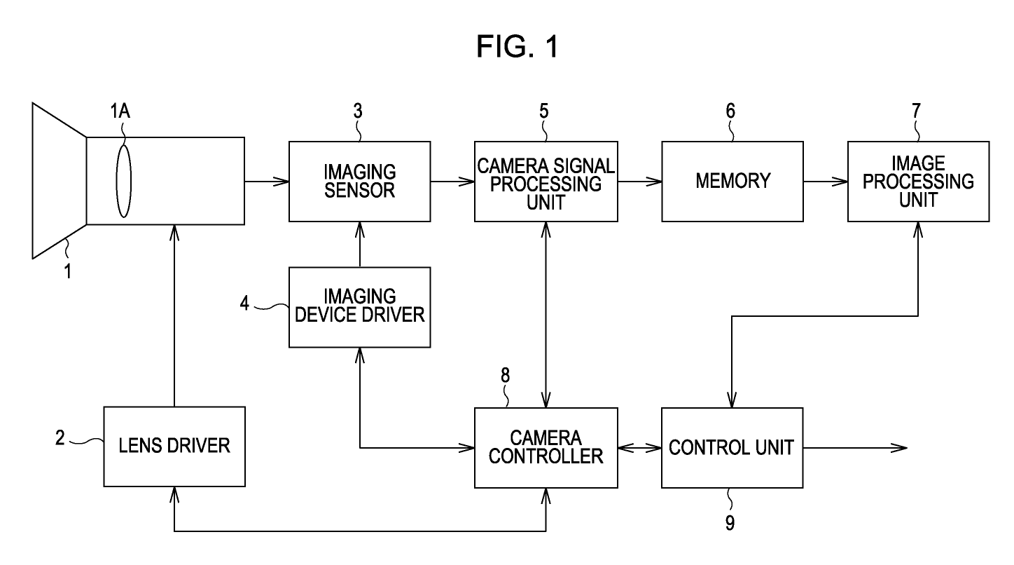

FIG. 1 shows an example of a configuration of an image processing apparatus according to an embodiment of the present invention. The image processing apparatus captures an image of a subject, which is a color object whose surface has a plurality of colors. On the basis of the captured image, the image processing apparatus determines whether the subject is a registered predetermined color object whose surface has a plurality of colors (hereinafter referred to as a model) and recognizes the model on the basis of the determination result. This image processing apparatus is used as, for example, a robot control apparatus.

A lens block 1, including a lens such as a zoom lens 1A, is driven by a lens driver 2, allowing incident light (image of a subject) to be input to an imaging sensor 3.

The imaging sensor 3 performs photoelectric conversion on the input optical image so as to generate imaging signals and supplies the imaging signals to a camera signal processing unit 5 under control by an imaging device driver 4.

The camera signal processing unit 5 performs a sampling process and a YC separating process on the imaging signals received from the imaging sensor 3 so as to obtain luminance and chrominance signals, and outputs those signals to a memory 6.

The memory 6 temporarily stores video signals supplied from the camera signal processing unit 5 and sequentially supplies the video signals in units of frames to an image processing unit 7 in accordance with a reading command from the image processing unit 7.

The image processing unit 7 performs image processing (described below) on an image corresponding to the video signals read from the memory 6 (hereinafter referred to as an input image) and determines whether the subject in the input image is a model that is registered in advance so as to perform model recognition. The image processing unit 7 then supplies a result of the model recognition to a control unit 9.

A camera controller 8 controls each unit related to imaging.

The control unit 9 controls each unit of the apparatus.

FIG. 2 shows an example of a configuration of the image processing unit 7.

An image input unit 11 receives video signals read from the memory 6 and supplies them to a color extracting unit 12.

The color extracting unit 12 determines color types of respective pixels constituting an input image corresponding to the video signals supplied from the image input unit 11 on the basis of a color table (described below) stored in advance in a storage unit 21, creates a color ID image of the same size as that of the input image, and supplies the color ID image to a color area detecting unit 13. In the color ID image, color IDs of determined colors are set at positions of the respective pixels of the input image.

The color area detecting unit 13 defines color areas in the color ID image supplied from the color extracting unit 12, each color area being a group of adjoining pixels of the same color, and supplies information about the size and so on of each color area (hereinafter referred to as color area information) to a matching unit 14.

On the basis of the color area information of the color areas on the input image supplied from the color area detecting unit 13 and color area information of color areas formed on a captured image including a model as a subject (hereinafter referred to as a reference image) stored in advance in a storage unit 22, the matching unit 14 detects pairs of a color area on the reference image and a color area on the input image that can correspond to the same part of the same model (hereinafter referred to as candidate pairs).

The matching unit 14 supplies color area information of the color areas of the detected candidate pairs to a recognizing unit 15.

On the basis of the color area information of the candidate pairs supplied from the matching unit 14, the recognizing unit 15 determines whether the color area on the reference image and the color area on the input image in each of the candidate pairs have a relationship of being able to be transformed in attitude with a common attitude parameter, and performs model recognition on the basis of the determination result.

If the recognizing unit 15 can recognize the model in the input image, that is, if the subject in the input image is the model, the recognizing unit 15 then detects the position of the subject (model) in the input image on the basis of the attitude parameter at that time, and outputs the detected position to the control unit 9.

Hereinafter, details of the recognizing process in the image processing unit 7, that is, a color extracting process in the color extracting unit 12, a color area detecting process in the color area detecting unit 13, a matching process in the matching unit 14, a recognizing process in the recognizing unit 15, and a position detecting process in the recognizing unit 15, are described in this order.

First, the color extracting process in the color extracting unit 12 is described.

For example, when an input image is a color image based on a YUV method, the color extracting unit 12 determines color types of respective pixels in the input image on the basis of luminance level data indicating a signal level Y of a luminance signal of a pixel value of each pixel in the input image (hereinafter referred to as an input luminance signal Y); color level data indicating a color signal level U of a blue color signal (hereinafter referred to as an input color signal U); and color level data indicating a color signal level V of a red color signal (hereinafter referred to as an input color signal V).

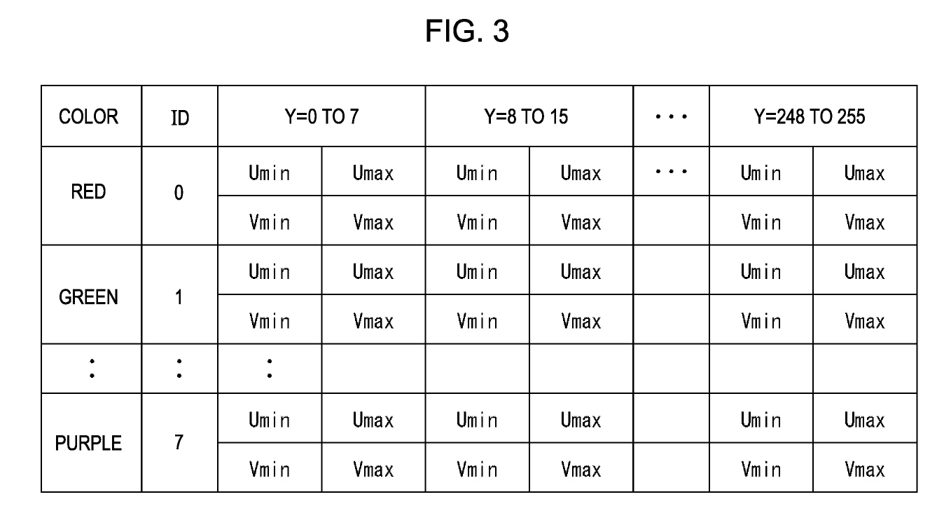

FIG. 3 shows an example of the color table stored in the storage unit 21. In this color table, color IDs of eight colors are set, each color ID being set on the basis of a maximum Umax and a minimum Umin of the input color signal U and a maximum Vmax and a minimum Vmin of the input color signal V in each level of luminance gradation (32-level gradation in FIG. 3).

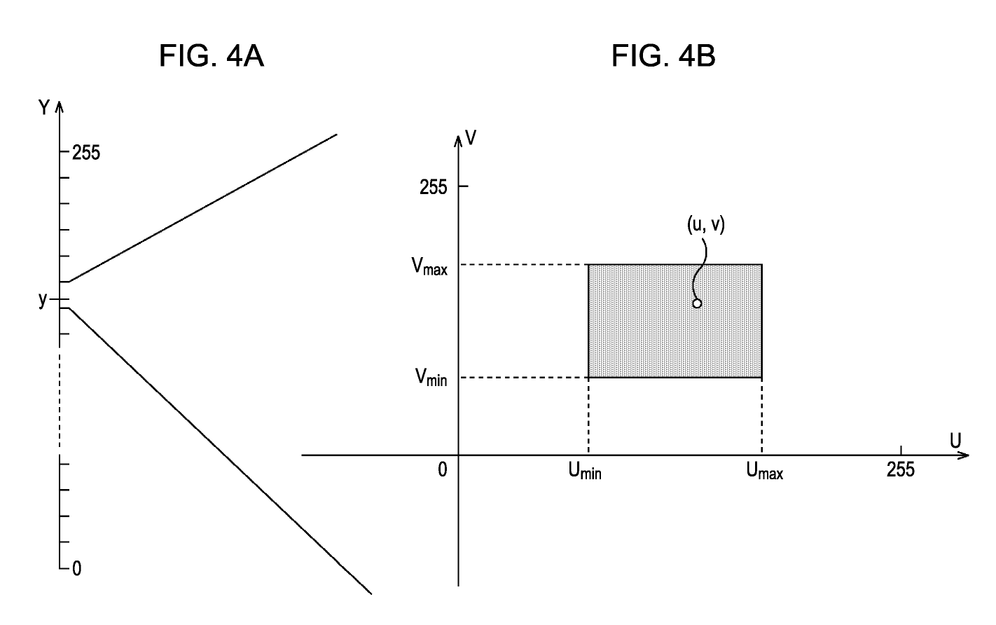

In this color table, as shown in FIGS. 4A and 4B, color types are specified on the basis of each level of luminance gradation (FIG. 4A) for each rectangular area (FIG. 4B) defined by the maximum Umax and minimum Umin of the input color signal U and the maximum Vmax and minimum Vmin of the input color signal V of each color.

Now, the color extracting process based on the color table shown in FIG. 3 is described. In order to speed up the process, look-up tables having an arrangement according to the gradation of the input luminance signal Y for the input color signals U and V are created on the basis of the color table shown in FIG. 3 so that the color ID of each pixel is directly detected on the basis of a pixel value with reference to the look-up tables.

That is, two look-up tables are created, one for the input color signal U and the other for the input color signal V. When each of the input luminance signal Y, the input color signal U, and the input color signal V is represented by 8 bits and when the input luminance signal Y has 32-level gradation, each look-up table is made up of 32 items and 256 items arranged two-dimensionally. In the example shown in FIG. 3, eight colors are set in the table, and thus elements of each table are expressed by eight-bit strings.

Then, in each color ID, values of Umax and Umin of the input color signal U and values of Vmax and Vmin of the input color signal V corresponding to gradation i (i=1, 2, . . . , 32) and the color ID are read from the color table shown in FIG. 3. Then, “1” is set to the j-th bit corresponding to the color ID of two-dimensionally arranged elements u_table[i][Umin] to u_table[i][Umax] for the input color signal U and two-dimensionally arranged elements v_table[i][Vmin] to v_table[i][Vmax] for the input color signal V, whereas “0” is set to the j-th bit of the elements of the other arrangements of u_table[i] and v_table[i].

For example, assuming that the gradation of the input luminance signal Y is 5, (Umin, Umax)=(50, 64), and (Vmin, Vmax)=(129, 154), the color ID is 3. In that case, “1” is set to the third bit of the elements u_table[5][50] to u_table[5][64] and the elements v_table[5][129] to v_table[5][154], whereas “0” is set to the third bit of the elements of the other arrangements of u_table[5] and v_table[5].

This process is performed for each color.

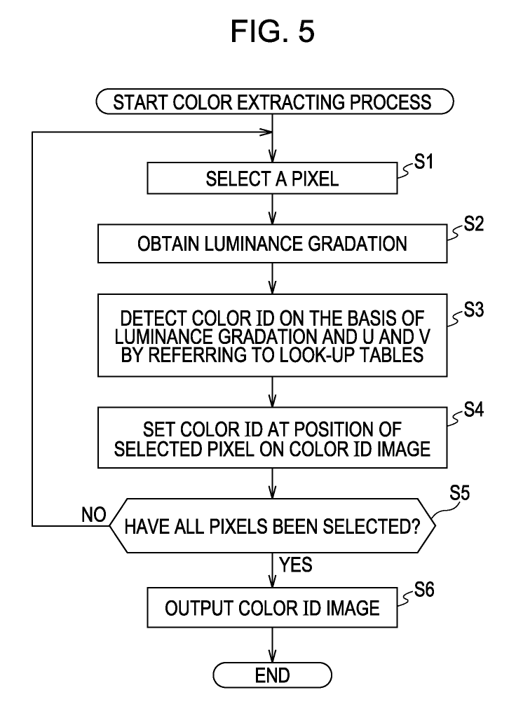

The color extracting process using the look-up tables created in the above-described manner is described with reference to the flowchart shown in FIG. 5.

In step S1, the color extracting unit 12 selects a pixel from an input image in the order from the upper left along a raster.

In step S2, the color extracting unit 12 detects gradation of the input luminance signal Y of the pixel selected in step S1. For example, when the input luminance signal Y is 8-bit data, the gradation of the input luminance signal Y can be obtained by shifting 4 bits to the right.

In step S3, the color extracting unit 12 refers to the arrangement of the gradation obtained in step S2 in the look-up tables, reads a color ID (u_table[Y][U], v_table[Y][V]) corresponding to the input color signals U and V of the pixel selected in step S1, and obtains a bit string through AND operation as a color ID.

In step S4, the color extracting unit 12 sets the color ID detected in step S3 at the position corresponding to the pixel selected in step S1 on a color ID image, which is separately provided and which has the same size as that of the input image.

In step S5, the color extracting unit 12 determines whether all of the pixels in the input image have been selected. If it is determined that a pixel that has not been selected exists, the process returns to step S1. That is, a next pixel in the input image is selected, and steps S2 to S5 are performed on the selected pixel.

If it is determined in step S5 that all of the pixels have been selected, the process proceeds to step S6, where the color extracting unit 12 supplies the color ID image created in steps S1 to S5, in which color IDs indicating color types of the respective pixels are set at positions corresponding to the pixels, to the color area detecting unit 13.

The above-described color extracting process is performed on each frame of the input image.

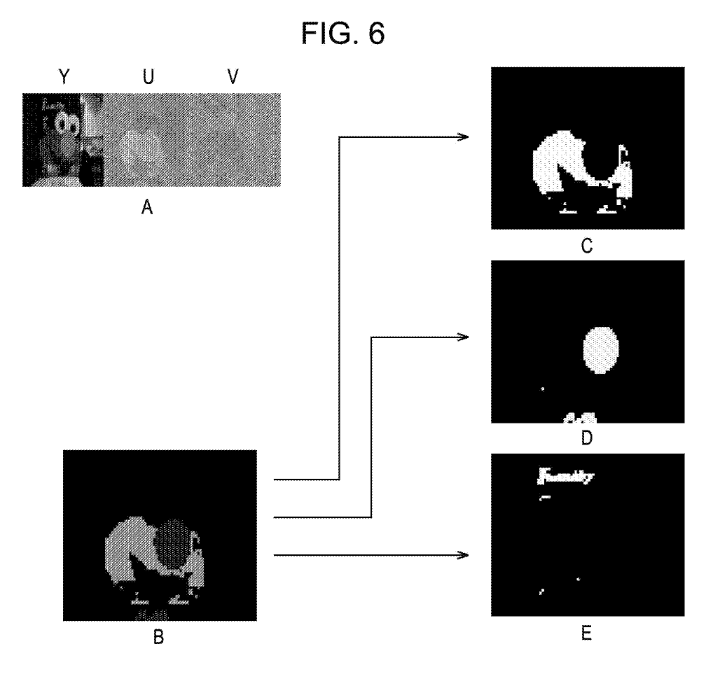

FIG. 6 shows a specific example of the above-described color extracting process. In FIG. 6, A shows images corresponding to the input luminance signal Y, the input color signal U, and the input color signal V of the input image. B shows a color bitmap image of the input image. As shown in the figure, after the color extracting process has been performed on the input image, the color ID image is created in which a red color ID (10000000) is set at the position corresponding to a pixel in a face of a doll on the input image shown in C, an orange color ID is set at the position corresponding to a pixel in a nose on the input image shown in D, and an yellow color ID is set at the position corresponding to a pixel in a character on the input image shown in E.

Next, the color area detecting process in the color area detecting unit 13 is described with reference to the flowchart shown in FIG. 7.

After the color ID image has been supplied from the color extracting unit 12, the color area detecting unit 13 selects a pixel in the color ID image along a raster in step S11 and performs a merge process in step S12.

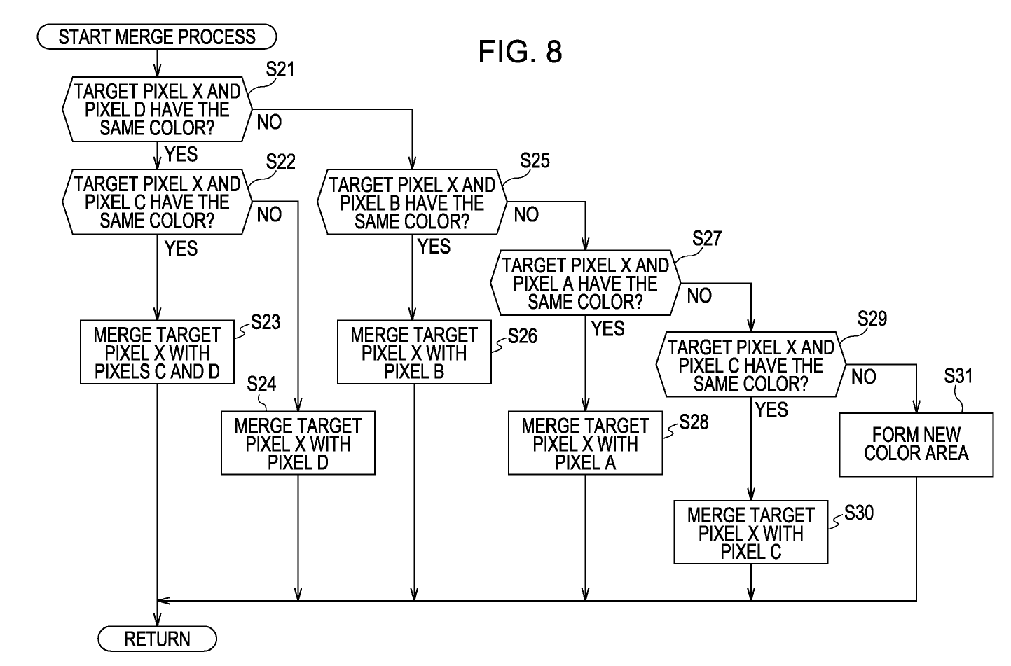

The merge process is described with reference to FIG. 8.

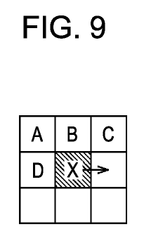

In step S21, the color area detecting unit 13 regards the pixel selected in step S11 as a target pixel X, as shown in FIG. 9. Then, the color area detecting unit 13 determines whether the target pixel X and a pixel D on the immediate left have the same color on the basis of the color IDs of those pixels. If the target pixel X and the pixel D have the same color, the process proceeds to step S22.

Herein, assume that a predetermined area ID was set to each of pixels A, B, C, and D in a process described below, when those pixels were the target pixel X.

In step S22, the color area detecting unit 13 determines whether the target pixel X and a pixel C on the upper right have the same color on the basis of the color IDs of those pixels. If the target pixel X and the pixel C have the same color, the process proceeds to step S23, where the color area detecting unit 13 merges the target pixel X with the pixels D and C.

More specifically, the color area detecting unit 13 selects any one of the pixels D and C, and replaces the area ID of the non-selected pixel by the area ID of the selected pixel. Also, the color area detecting unit 13 sets the area ID of the target pixel X to the area ID of the selected pixel.

If it is determined in step S22 that the color of the target pixel X is different from the color of the pixel C, the process proceeds to step S24, where the color area detecting unit 13 merges the target pixel X with the pixel D.

More specifically, the color area detecting unit 13 sets the area ID of the target pixel X to the area ID of the pixel D.

If it is determined in step S21 that the color of the target pixel X is different from the color of the pixel D, the process proceeds to step S25, where the color area detecting unit 13 determines whether the target pixel X and an immediately above pixel B have the same color on the basis of the color IDs of those pixels. If the target pixel X and the pixel B have the same color, the process proceeds to step S26.

In step S26, the color area detecting unit 13 merges the target pixel X with the pixel B. More specifically, the color area detecting unit 13 sets the area ID of the target pixel X to the area ID of the pixel B.

If it is determined in step S25 that the color of the target pixel X is difference from the color of the pixel B, the process proceeds to step S27, where the color area detecting unit 13 determines whether the target pixel X and a pixel A on the upper left have the same color on the basis of the color IDs of those pixels. If the target pixel X and the pixel A have the same color, the process proceeds to step S28.

In step S28, the color area detecting unit 13 merges the target pixel X with the pixel A. More specifically, the color area detecting unit 13 sets the area ID of the target pixel X to the area ID of the pixel A.

If it is determined in step S27 that the color of the target pixel X is difference from the color of the pixel A, the process proceeds to step S29, where the color area detecting unit 13 determines whether the target pixel X and the pixel C on the upper right have the same color on the basis of the color IDs of those pixels. If the target pixel X and the pixel C have the same color, the process proceeds to step S30.

In step S30, the color area detecting unit 13 merges the target pixel X with the pixel C. More specifically, the color area detecting unit 13 sets the area ID of the target pixel X to the area ID of the pixel C.

If it is determined in step S29 that the color of the target pixel X is different from the color of the pixel C, that is, if the color of the target pixel X is different from the colors of all of the pixels A, B, C, and D, the process proceeds to step S31, where the color area detecting unit 13 sets a new area ID to the target pixel X. More specifically, the color area detecting unit 13 increments the value of a built-in counter by 1, and the incremented value is set as a new area ID of the target pixel X. Note that the color area detecting unit 13 initializes the counter to 1 at start of the process.

After step S23, S24, S26, S28, S30, or S31, the process proceeds to step S13 in FIG. 7.

In step S13, the color area detecting unit 13 updates information about the area to which a new pixel is added in step S12. The information includes the number of pixels in the area, a total sum of the positions of the pixels, and a minimum position and a maximum position of the pixels in the color area.

Then, in step S14, the color area detecting unit 13 determines whether all of the pixels in the color ID image have been selected. If a pixel that has not been selected exists, the process returns to step S11. That is, a next pixel is selected from the color ID image, and steps S12 to S14 are performed on the selected pixel.

If it is determined in step S14 that all of the pixels have been selected, the process proceeds to step S15, where the color area detecting unit 13 supplies color area information of each color area to the matching unit 14. The color area information includes the number of pixels updated in step S13, a minimum position and a maximum position of the pixels in the area, the center of gravity of the area obtained as a result of dividing a total sum of the positions of the pixels by the number of pixels, a moment calculated in expressions (1), and the color ID of each color area.

In expressions (1), xi (i=1, 2, . . . , N) and yi are coordinates (x, y) of the pixel specified by a variable i on the input image, and N is the number of pixels in the area.

$${I}_{xx} = \frac{{\sum }_{i}^{N} {x}_{i}^{2}}{N} - {( \frac{{\sum }_{i}^{N} {x}_{i}}{N} )}^{2} \\ {I}_{yy} = \frac{{\sum }_{i}^{N} {y}_{i}^{2}}{N} - {( \frac{{\sum }_{i}^{N} {y}_{i}}{N} )}^{2} \\ {I}_{xy} = \frac{{\sum }_{i}^{N} {x}_{i}^{2}}{N} - ( \frac{{\sum }_{i}^{N} {x}_{i}}{N} ) ( \frac{{\sum }_{i}^{N} {y}_{i}}{N} ) \qquad ( 1 )$$

The color areas are detected in the above-described manner.

As described above with reference to FIG. 9, the target pixel X is selected one by one in the direction indicated by the arrow, the color of the selected target pixel X is compared with the color of adjoining pixels on the upper left, immediately above, upper right, and immediately left, and the area IDs of the adjoining pixels are set to the area ID of the target pixel X on the basis of the comparison result. Accordingly, the same area ID is set to eight adjoining pixels of the same color, so that one color area is formed.

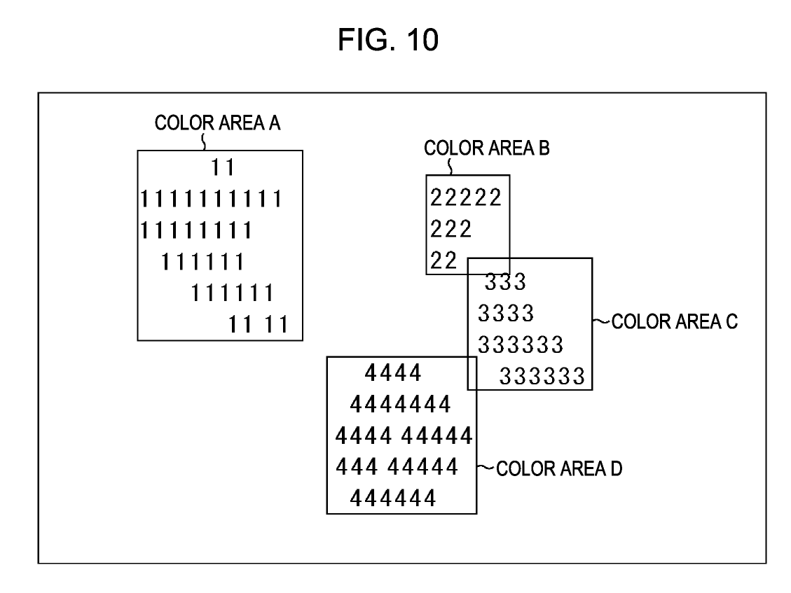

FIG. 10 schematically shows color areas formed by the above-described color area detecting process. In the example shown in FIG. 10, the following color areas are formed: a color area A made up of adjoining pixels having a red color ID (not shown, also in the other areas) and having an area ID of 1; a color area B made up of adjoining pixels having a blue color ID and having an area ID of 2; a color area C made up of adjoining pixels having a red color ID and having an area ID of 3; and a color area D made up of adjoining pixels having a green color ID and having an area ID of 4.

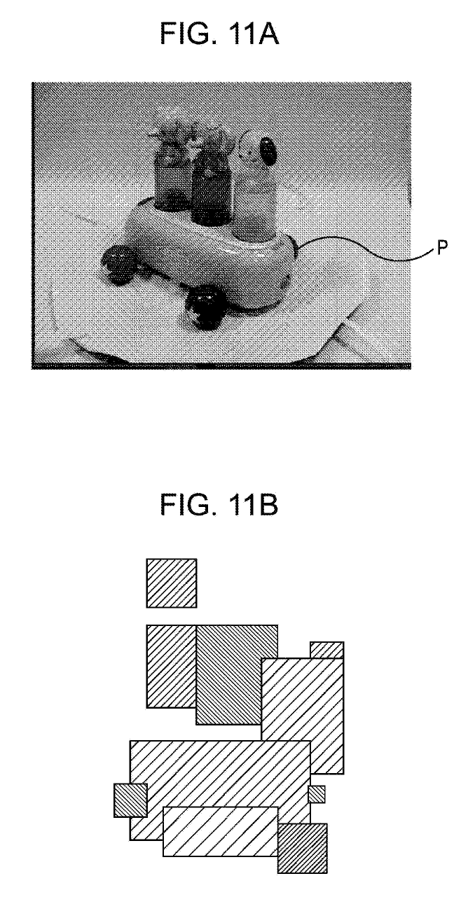

FIGS. 11A and 11B show an input image and color areas corresponding thereto. When an input image of a subject P shown in FIG. 11A is input, color areas shown in FIG. 11B are detected. Respective hatch patterns applied to the color areas shown in FIG. 11B correspond to colors of the color areas. That is, color areas of the same hatch pattern are made up of pixels having the same color ID.

As described above, the color ID is a bit string in which 1 is set to the bit corresponding to the color of the pixel. However, 1 may be set to a plurality of bits depending on a pixel value. In that case, among the plurality of bits of 1, bits other than the lowest bit are set to 0 (the color corresponding to the lowest bit is set), so that the color ID is set.

Hereinafter, the matching process in the matching unit 14 is described.

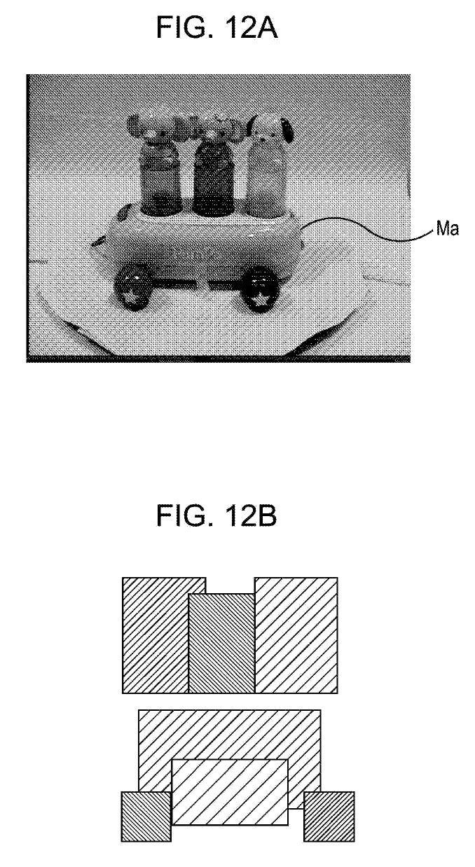

The color areas on a reference image that are referred to in the matching process are shown in FIG. 12B. Those color areas are detected through the above-described color extracting process and color area detecting process performed on the reference image, which is obtained by capturing an image of a model Ma shown in FIG. 12A from a direction (the subject P shown in FIG. 11A is the model Ma). Information including color area information of the color areas (hereinafter referred to as model information) is stored in the storage unit 22. The respective hatch patterns applied to the color areas shown in FIG. 12B correspond to the colors of the color areas.

A plurality of models can be registered. In that case, a plurality of pieces of model information are stored in the storage unit 22.

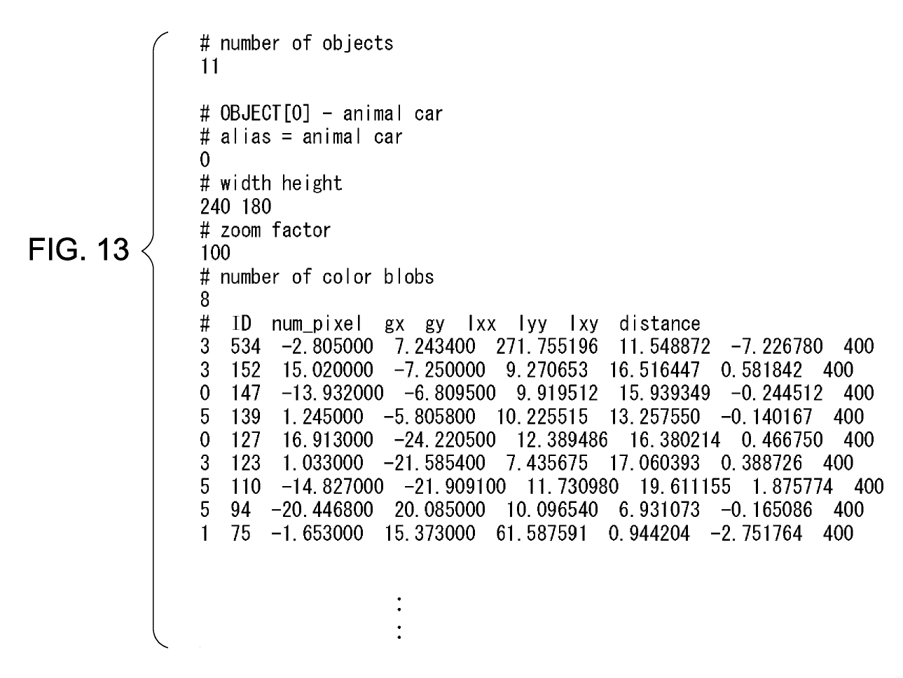

FIG. 13 shows a description example of the model information.

In the example shown in FIG. 13, a line starting with # is a comment line. The number of registered models “number of objects” is 11. That is, in the example shown in FIG. 13, 11 pieces of model information are described. However, for simplicity, only the first piece of the model information is shown in FIG. 13.

According to the model information, the model ID “OBJECT[]” is 0, the model name “alias” is animal car, the size of the reference image “width height” is (240 180), the angle of view at image capturing of the model “zoom factor” is 100, and the number of color types “number of color blobs” is 8.

The description is followed by color area information of each color area. In this example, the color ID “ID”, the number of pixels “num_pixel”, the position of center of gravity (x, y) “gx, gy”, the moment amount “Ixx Iyy Ixy”, and the distance (mm) between the model and the lens block 1 at image capturing “distance” are described for each color area. In the example shown in FIG. 13, color area information of 9 color areas is described.

The model information of the second to eleventh models is described in the same manner.

Hereinafter, the matching process based on the model information shown in FIG. 13 is described with reference to the flowchart shown in FIG. 14.

After receiving the color area information of the color areas detected from the input image from the color area detecting unit 13, the matching unit 14 selects a piece of model information stored in the storage unit 22 in step S51.

In step S52, the matching unit 14 selects a piece of color area information in the model information selected in step S51.

In step S53, the matching unit 14 selects a piece of color area information in the color area information of the input image supplied from the color area detecting unit 13.

In step S54, the matching unit 14 determines, on the basis of the both pieces of color area information selected in steps S52 and S53, whether the color areas corresponding to the both pieces of color area information have the same color and whether the difference in aspect ratio of the both areas is within a predetermined range, and determines whether the both areas correspond to each other, that is, whether the both areas can correspond to the same part of the same model.

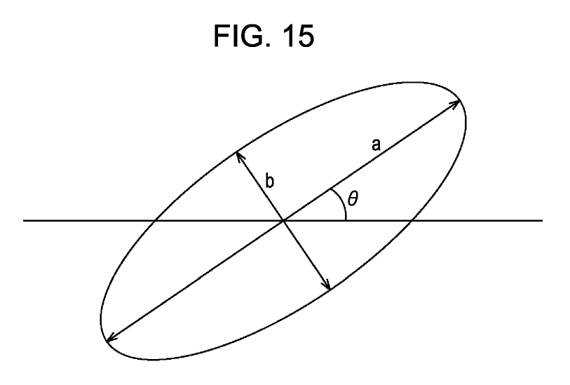

Whether the both color areas have the same color is determined through matching between color IDs in the both pieces of color area information. The aspect ratio of each color area can be calculated on the basis of the ratio between major axis a and minor axis b (minor axis b÷major axis a) of an ellipse when the color area is regarded as an ellipse as shown in FIG. 15.

The major axis a and the minor axis b can be calculated by using expressions (2), in which B and D can be obtained on the basis of each moment in the color area information, as shown in expressions (3).

$$\begin{matrix}a = \sqrt{\frac{B + D}{2}} \\ b = \sqrt{\frac{B - D}{2}} & ( 2 ) \\ B = {I}_{xx} + {I}_{yy} \\ {B}_{2} = {I}_{xx} - {I}_{yy} \\ D = \sqrt{{B}_{2}^{2} + 4 {I}_{xy}^{2}} & ( 3 )\end{matrix}$$

The angle θ to specify the major axis a can be obtained by using expression (4).

$$θ = 0.5 {tan}^{- 1} ( \frac{2 {I}_{xy}}{{B}_{2}} ) \qquad ( 4 )$$

The aspect ratios are compared for the following reason. That is, even if the two areas have the same color, the areas do not correspond to each other if they are significantly different in shape.

Referring back to FIG. 14, if it is determined in step S54 that the both color areas correspond to each other, the process proceeds to step S55, where the matching unit 14 holds the piece of color area information selected in step S52 and the piece of color area information selected in step S53 as color area information of a candidate pair, and registers the candidate pair.

If it is determined in step S54 that the both areas do not correspond to each other or after the candidate pair is registered in step S55, the process proceeds to step S56, where the matching unit 14 determines whether all pieces of the color area information about the input image have been selected. If a piece of the color area information that has not been selected exists, the process returns to step S53. That is, another piece of the color area information about the input image is selected, and steps S54 to S56 are performed on the selected piece.

If it is determined in step S56 that all pieces of the color area information about the input image have been selected, the process proceeds to step S57, where matching unit 14 determines whether all pieces of the color area information in the model information have been selected. If a piece of the color area information that has not been selected exists, the process returns to step S52. That is, another piece of the color area information in the model information selected in step S51 is selected and steps S53 to S57 are performed on the selected piece.

If it is determined in step S57 that all pieces of the color area information in the model information have been selected, the process proceeds to step S58, where the matching unit 14 determines whether all pieces of the model information have been selected. If a piece of the model information that has not been selected exists, the process returns to step S51. That is, another piece of the model information is selected and steps S52 to S58 are performed on the selected piece.

If it is determined in step S58 that all pieces of the model information have been selected, the process proceeds to step S59, where the matching unit 14 outputs the color area information of the candidate pairs of color areas registered in step S55 to the recognizing unit 15. Accordingly, the process ends.

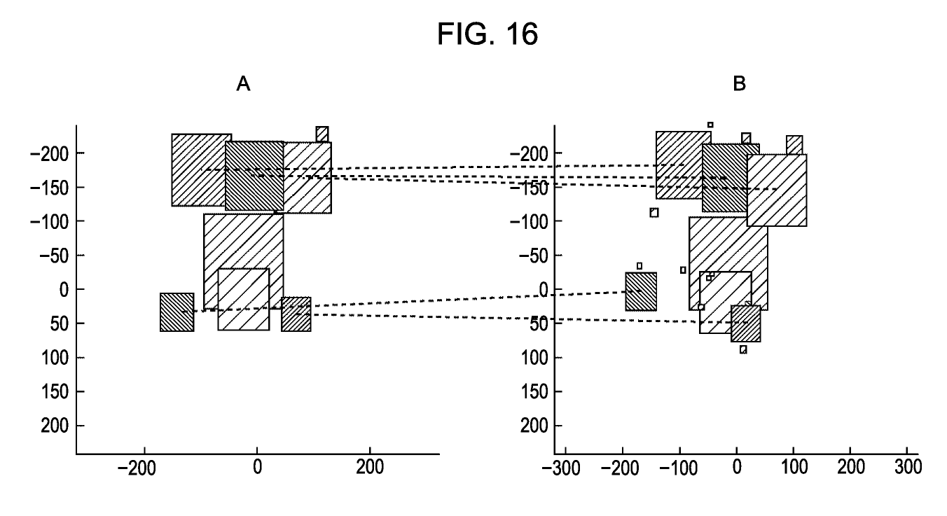

According to the above-described matching process, when the color areas on the reference image are formed in the manner shown in graph A in FIG. 16 and when the color areas on the input image are formed in the manner shown in graph B in FIG. 16, the color areas connected to each other by broken lines are regarded as candidate pairs (actually, other color areas are also regarded as candidate pairs).

Hereinafter, the recognizing process in the recognizing unit 15 is described. First, the principle thereof is explained.

Three-dimensional coordinates (X1, Y1, Z1) of an arbitrary position on an object viewed from a direction and three-dimensional coordinates (X2, Y2, Z2) of the position on the object viewed from another direction have a relationship of being able to be transformed in attitude as shown in expression (5), by using a rotation matrix R of predetermined roll angle φ, pitch angle θ, and yaw angle ψ shown in expression (6) and predetermined translation ΔX, ΔY, and ΔZ.

$$\begin{matrix}( \begin{matrix}{X}_{2} \\ {Y}_{2} \\ {Z}_{2}\end{matrix} ) = R ( \begin{matrix}{X}_{1} \\ {Y}_{1} \\ {Z}_{1}\end{matrix} ) + ( \begin{matrix}Δ X \\ Δ Y \\ Δ Z\end{matrix} ) & ( 5 ) \\ R ( ϕ , θ , ψ ) = [ \begin{matrix}cos ϕ & - sin ϕ & 0 \\ sin ϕ & cos ϕ & 0 \\ 0 & 0 & 1\end{matrix} ] [ \begin{matrix}cos θ & 0 & sin θ \\ 0 & 1 & 0 \\ - sin θ & 0 & cos θ\end{matrix} ] [ \begin{matrix}1 & 0 & 0 \\ 0 & cos ψ & - sin ψ \\ 0 & sin ψ & cos ψ\end{matrix} ] & ( 6 )\end{matrix}$$

That is, when there are a plurality of pairs of three-dimensional coordinates (X1, Y1, Z1) of the center of gravity of a color area on the reference image and three-dimensional coordinates (X2, Y2, Z2) of the center of gravity of a color area on the input image, each pair corresponding to the same part of the model, expression (5) is established by the same rotation matrix R and translation ΔX, ΔY, and ΔZ for those pairs of color areas.

Herein, on the basis of this principle, it is determined whether expression (5) is established by a common rotation matrix R and translation ΔX, ΔY, and ΔZ in a certain number or more of candidate pairs. In other words, it is determined whether there are a certain number or more of candidate pairs in which expression (5) is established by a common rotation matrix R and translation ΔX, ΔY, and ΔZ, and the model in the input image is recognized on the basis of the determination result.

The center of gravity of the color area on the reference image and the center of gravity of the color area on the input image are indicated by two-dimensional coordinates in the color area information. Therefore, expression (5) is transformed to expression (7), which corresponds to two-dimensional coordinates.

$$( \begin{matrix}\begin{matrix}Δ X \\ Δ Y\end{matrix} \\ Δ Z\end{matrix} ) = \sqrt{\frac{{S}_{12}}{{s}_{2}}} ( \begin{matrix}\begin{matrix}{x}_{2} \\ {y}_{2}\end{matrix} \\ {f}_{2}\end{matrix} ) - \sqrt{\frac{{S}_{12}}{{s}_{1}}} R ( \begin{matrix}\begin{matrix}{x}_{1} \\ {y}_{1}\end{matrix} \\ {f}_{1}\end{matrix} ) \qquad ( 7 )$$

In expression (7), x1 and y1 are two-dimensional coordinates of the center of gravity of the color area on the reference image constituting a candidate pair (two-dimensional coordinates of the center of gravity included in the color area information), whereas x2 and y2 are two-dimensional coordinates of the center of gravity of the color area on the input image (two-dimensional coordinates of the center of gravity included in the color area information).

In expression (7), f1 is a distance corresponding to the angle of view “zoom factor” included in the color area information about the reference image, whereas f2 is a focal length at image capturing of the subject and is notified to the recognizing unit 15 via the control unit 9. In order to recognize remote and nearby objects, a zoom factor of the camera is appropriately changed and thus the focal length f2 is also changed. Thus, the focal length f1 about the reference image may be different from the focal length f2 about the input image.

Now, a method for transforming expression (5) to expression (7) is described.

A relationship of expressions (8) exists between three-dimensional coordinates (X, Y, Z) of an arbitrary position of an object and two-dimensional coordinates (x, y) of the arbitrary position of the object projected onto a plane. The relationship also exists between a surface area S of the object and an area s of the object on the plane.

$$x = f \frac{X}{Z} \\ y = f \frac{Y}{Z} \\ s = hl = ( f \frac{H}{Z} ) ( f \frac{L}{Z} ) = {( \frac{f}{Z} )}^{2} S \qquad ( 8 )$$

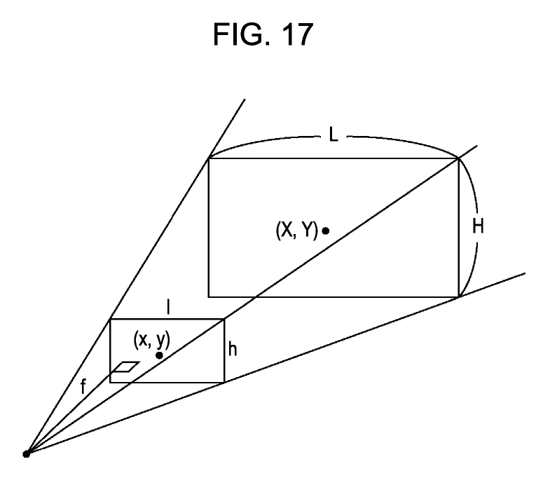

In expressions (8), f is a distance from a view point (distance corresponding to a focal length), as shown in FIG. 17. H and L are vertical and lateral lengths of a surface area of a three-dimensional object, and h and l are vertical and lateral lengths of the surface area projected onto a two-dimensional plane.

Expressions (8) can be expanded to expressions (9).

$$Z = \sqrt{\frac{S}{s}} f \\ X = \frac{x}{f} Z = \sqrt{\frac{S}{s}} x \\ Y = \frac{y}{f} Z = \sqrt{\frac{S}{s}} y \qquad ( 9 )$$

By calculating expressions (9), on the basis of the two-dimensional coordinates (x1, y1) of the center of gravity of the color area on the reference image and the area s1, which are known in this example, the three-dimensional coordinates of the center of gravity can be obtained, as shown in expressions (10). Also, on the basis of the two-dimensional coordinates (x2, y2) of the center of gravity of the color area on the input image and the area s2, the three-dimensional coordinates of the center of gravity can be obtained, as shown in expressions (11). Substitution of expressions (10) and (11) into expression (5) yields expression (7).

$$\begin{matrix}{Z}_{1} = \sqrt{\frac{{S}_{12}}{{s}_{1}}} {f}_{1} \\ {X}_{1} = \frac{{x}_{1}}{{f}_{1}} {Z}_{1} = \sqrt{\frac{{S}_{12}}{{s}_{1}}} {x}_{1} \\ {Y}_{1} = \frac{{y}_{1}}{{f}_{1}} {Z}_{1} = \sqrt{\frac{{S}_{12}}{{s}_{1}}} {y}_{1} & ( 10 ) \\ {Z}_{2} = \sqrt{\frac{{S}_{12}}{{s}_{2}}} {f}_{2} \\ {X}_{2} = \frac{{x}_{2}}{{f}_{2}} {Z}_{2} = \sqrt{\frac{{S}_{12}}{{s}_{2}}} {x}_{2} \\ {Y}_{2} = \frac{{y}_{2}}{{f}_{2}} {Z}_{2} = \sqrt{\frac{{S}_{12}}{{s}_{2}}} {y}_{2} & ( 11 )\end{matrix}$$

In this way, expression (5) can be transformed to expression (7).

In this example, the surface area S12 of each area of the object in expressions (10) and (11) is unknown. Thus, it is assumed that the value of expression (12) is equal in all color areas on the reference image, and expression (7) is further transformed to expression (13), so that translation ΔX′, ΔY′, and ΔZ′ as approximation of translation ΔX, ΔY, and ΔZ is obtained.

$$\begin{matrix}\sqrt{\frac{{S}_{12}}{{s}_{1}}} & ( 12 ) \\ ( \begin{matrix}\begin{matrix}Δ {X}^{′} \\ Δ {Y}^{′}\end{matrix} \\ Δ {Z}^{′}\end{matrix} ) ≡ \frac{\sqrt{{s}_{1}}}{\sqrt{{S}_{12}}} ( \begin{matrix}\begin{matrix}Δ X \\ Δ Y\end{matrix} \\ Δ Z\end{matrix} ) = \frac{\sqrt{{s}_{1}}}{\sqrt{{s}_{2}}} ( \begin{matrix}\begin{matrix}{x}_{2} \\ {y}_{2}\end{matrix} \\ {f}_{2}\end{matrix} ) - R ( \begin{matrix}\begin{matrix}{x}_{1} \\ {y}_{1}\end{matrix} \\ {f}_{1}\end{matrix} ) & ( 13 )\end{matrix}$$

The fact that the value of expression (12) is equal in all color areas on the reference image means that respective parts corresponding to the color areas of the model are at almost the same depth from the view point, because the value of expression (12) is a parameter that is proportional to the distance. When the variation of distances between the lens block 1 and the respective parts corresponding to the color areas is sufficiently small compared to the distance between the entire model and the lens block 1 (or depth), the value of expression (12) is equal in all color areas on the reference image.

Therefore, by capturing an image of the model so that the respective parts corresponding to the color areas of the model are horizontal to the image capturing direction, this approximation is established and expression (13) can be used.

Hereinafter, the recognizing process is described with reference to the flowchart shown in FIG. 18.

After the color area information of the candidate pairs obtained from one frame of the input image is supplied from the matching unit 14, the recognizing unit 15 selects one of sets of roll angle, pitch angle, and yaw angle of predetermined value in step S71. For example, a plurality of sets of roll angle, pitch angle, and yaw angle are prepared in steps of 10 degrees (hereinafter these angles are collectively referred to as attitude angles when they need not be distinguished from each other), and one of the sets is selected.

In step S72, the recognizing unit 15 obtains a rotation matrix R by calculating expression (6) by using the roll angle, pitch angle, or yaw angle of the set selected in step S71.

In step S73, the recognizing unit 15 selects the color area information of one of the candidate pairs from the color area information supplied from the matching unit 14.

In step S74, the recognizing unit 15 calculates expression (13) by using the coordinates (x1, y1) of the center of gravity of the color area on the reference image and the coordinates (x2, y2) of the center of gravity of the color area on the input image in the color area information of the candidate pair selected in step S73, so as to obtain translation Δ′x, Δ′y, and Δ′z (hereinafter referred to as a translation vector Δ′ when they need not be distinguished from each other).

In step S75, the recognizing unit 15 casts the translation vector Δ′ obtained in step S74 to a three-dimensional space. Specifically, a grid of a predetermined range is provided on the three-dimensional space, and vote is performed in each of grid segments.

In step S76, the recognizing unit 15 determines whether all of the candidate pairs have been selected. If a candidate pair that has not been selected exists, the process returns to step S73. That is, another candidate pair is selected, and steps S74 to S76 are performed on the selected candidate pair.

If it is determined in step S76 that all of the candidate pairs have been selected, the process proceeds to step S77.

In step S77, the recognizing unit 15 selects the grid segment obtained the largest number of votes of translation vectors Δ′ about the respective candidate pairs calculated about the rotation matrix R of a set of roll angle, pitch angle, and yaw angle. Then, the recognizing unit 15 calculates an average of the translation vectors Δ′ cast to the grid segment, and regards the average as a peak of the translation vector Δ′.

In step S78, the recognizing unit 15 detects the translation vectors Δ′ cast within a range from the peak of the translation vector Δ′ calculated in step S77 to a threshold T.

In step S79, the recognizing unit 15 determines whether the candidate pairs that cast the translation vectors Δ′ detected in step S78 include a candidate pair in which one of the color areas is common to a color area of another candidate pair. If such a candidate pair exists, the process proceeds to step S80.

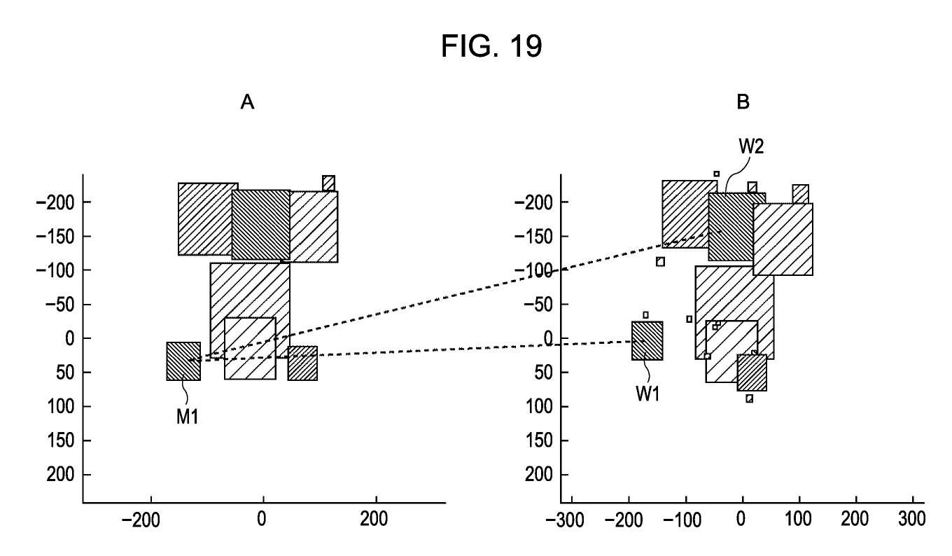

For example, as shown in FIG. 19, when a color area M1 on the reference image shown in graph A in FIG. 19 and a color area W1 on the input image shown in graph B in FIG. 19 form a candidate pair and when the color area M1 and a color area W2 form a candidate pair, the color area M1 is common to the both pairs of M1 and W1 and M1 and W2. Thus, the process proceeds to step S80.

When the number of colors is small, a pair of same color areas may exist in an object of many colors.

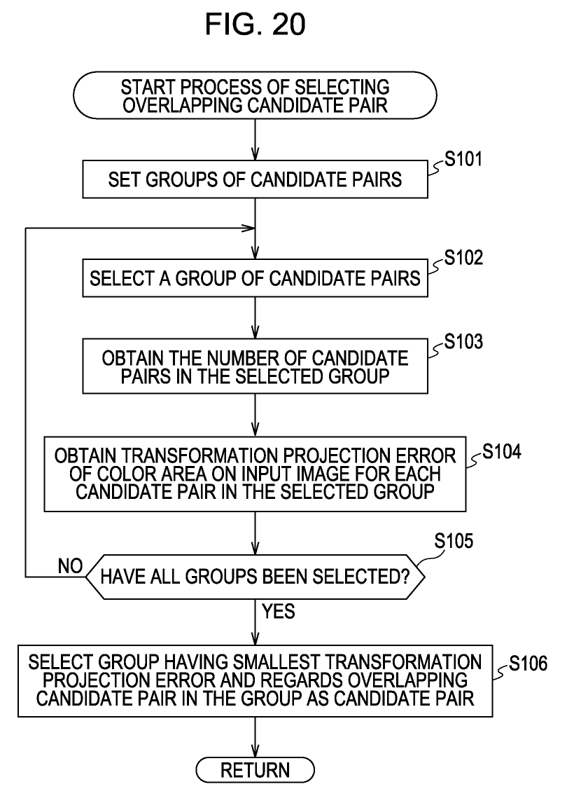

In step S80, a candidate pair is selected from among the candidate pairs in which one of color areas in one of the pairs is common to a color area of the other pair (hereinafter such candidate pairs are referred to as overlapping candidate pairs: in the example shown in FIG. 19, the candidate pair of color area M1 and color area W1 and the candidate pair of color area M1 and color area W2). That is, since the color area on the reference image and the color area on the input image corresponding to the same part of the model have a one-to-one relationship, the candidate pair of the color area on the reference image and the color area on the input image having the highest possibility of matching is selected from among the overlapping candidate pairs. This process is described below with reference to the flowchart shown in FIG. 20.

In step S101, the recognizing unit 15 sets, for each overlapping candidate pair, a group of an overlapping candidate pair and candidate pairs that are not overlapping. In the example shown in FIG. 19, a group of the candidate pair of the color area M1 and the color area W1 and candidate pairs that are not overlapping (candidate pairs except the candidate pair of the color area M1 and the color area W2); and a group of the candidate pair of the color area M1 and the color area W2 and candidate pairs that are not overlapping (candidate pairs except the candidate pair of the color area M1 and the color area W1) are set.

In step S102, the recognizing unit 15 selects one of the groups set in step S101. In step S103, the recognizing unit 15 obtains the number of candidate pairs in the selected group.

In step S104, for each of the candidate pairs included in the group selected in step S102, the recognizing unit 15 calculates expression (13) by using the coordinates (x1, y1) of the center of gravity of the color area on the reference image and the area s1 of the candidate pair, the area s2 of the color area on the input image, the rotation matrix R obtained in step S72 in FIG. 18, the peak of the translation vector Δ′ obtained in step S77, the distance f1, and the distance f2. Accordingly, the recognizing unit 15 obtains the two-dimensional coordinates of the center of gravity of the color area on the input image, and obtains a square error (transformation projection error) between the obtained two-dimensional coordinates and the two-dimensional coordinates included in the color area information of the color area on the input image.

In step S105, the recognizing unit 15 determines whether all of the set groups have been selected. If a group that has not been selected exists, the process returns to step S102. That is, another group is selected in step S102 and steps 103 to S105 are performed in the above-described manner.

If it is determined in step S105 that all of the groups have been selected, the process proceeds to step S106, where the recognizing unit 15 selects the group of the smallest transformation projection error from among the groups including the largest number of candidate pairs in the groups set in step S101. The overlapping candidate pair belonging to the group is regarded as a candidate pair, and the other overlapping candidate pair (candidate pair including the same color area as one of the color areas of the other candidate pair) is not regarded as a candidate pair.

In this way, one of the overlapping candidate pairs is selected. Then, the process proceeds to step S81 in FIG. 18.

In step S81, the recognizing unit 15 determines whether all of the sets of attitude angles have been selected. If a set that has not been selected exists, the process returns to step S71. That is, another set of attitude angles is selected in step S71, and steps S72 to S81 are performed on the basis of the selected attitude angles.

If it is determined in step S81 that all of the sets of attitude angles have been selected, the process proceeds to step S82, where the recognizing unit 15 determines whether the number of candidate pairs extracted in step S78 or the number of candidate pairs when an overlapping candidate pair is selected in step S80 is 60% or more of the number of the color areas on the reference image. If the number of the candidate pairs is 60% or more, that is, if there are a certain number or more of pairs of color areas in which expression (13) is established by a common rotation matrix R and translation ΔX, ΔY, and ΔZ (hereinafter referred to as a translation vector Δ), the process proceeds to step S83, where the recognizing unit 15 recognizes that the subject in the input image is the model and notifies the control unit 9 of the recognition result.

If it is determined in step S82 that the number of extracted candidate pairs is less than 60%, the recognizing unit 15 determines that the subject in the input image is not the model, and the process ends.

The recognizing process is performed in the above-described manner.

Hereinafter, the position detecting process in the recognizing unit 15 is described.

After recognizing the model, the recognizing unit 15 obtains the value of expression (12) by substituting the focal length f1 corresponding to the angle of view “zoom factor” in the model information and the distance (mm) “distance” z1 between the model and the camera at image capturing in the color area information of the reference image constituting the selected candidate pair into the expression of Z1 in expressions (10).

Then, the recognizing unit 15 substitutes the value of expression (12) and the translation vector Δ′ at recognition of the model into expression (13) so as to obtain the translation vector Δ.

Then, the recognizing unit 15 substitutes the coordinates (x1, y1) of the center of gravity in the color area information of the reference image of the selected candidate pair, the value of expression (12), and the focal length f1 corresponding to the angle of view “zoom factor” as model information into expressions (10), so as to obtain the three-dimensional coordinates (X1, Y1, Z1) corresponding to the coordinates (x1, y1).

Then, the recognizing unit 15 substitutes the three-dimensional coordinates (X1, Y1, Z1), the translation vector Δ, and the rotation matrix R at recognition of the model into expression (5), so as to calculate the three-dimensional coordinates (X2, Y2, Z2) of the model recognized in the input image.

In this way, the position of the recognized model (relative position from the robot) is detected.

In the above-described manner, the color extracting process, the color area detecting process, the matching process, the recognizing process, and the position detecting process are performed, so that the recognizing process in the image processing unit 7 is performed.

According to the above-described processes, color areas can be detected at high speed from an object (color object) having a plurality of colors. Furthermore, since the number of color areas in an image is not so large, matching can be performed at high speed. Accordingly, the model can be quickly recognized. Also, since the position relationship of a candidate pair of color areas having a relatively simple shape is verified, the model can be stably recognized even if a direction of viewing the object or the color areas thereof changes, and the model can be robustly recognized even if the attitude changes.

Furthermore, a pair of color areas having the same color and same position needs to exist, and thus the model can be recognized without being affected by a background color, unlike in recognition of a single-color object.

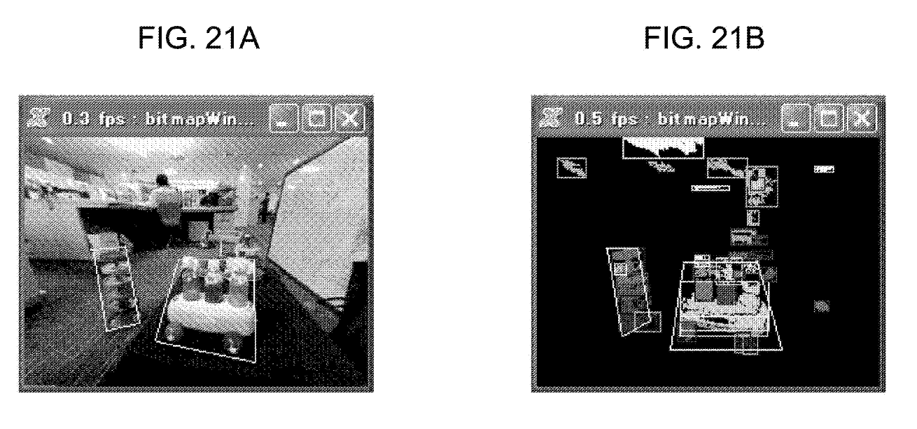

In the above-described embodiment, a model to be recognized is only one. Alternatively, in a case where a plurality of models are to be recognized as shown in FIG. 21A, each of the models can be recognized by detecting color areas, as shown in FIG. 21B.

In the above-described embodiment, only one reference image is prepared for the model. However, images of the model may be captured from different directions in order to create a plurality of reference images, and model information of those reference images can be held.

If an image of a subject to be recognized is captured with a rotation of 60 degrees or more from the direction of capturing an image of the model, a part that can be seen on the reference image may be hidden on the input image. In that case, it is difficult to recognize the model on the input image. If an image of the model is captured from that direction and if a reference image obtained accordingly is registered, the robot can recognize the model when seeing the subject to be recognized from that direction.

In this case, the same model ID can be attached to respective pieces of model information about the plurality of reference images of the model. Although overlapping candidate pairs may exist, the model can be recognized by the above-described selecting step (step S80).

In the above-described embodiment, the focal length f1 about the reference image and the focal length f2 about the input image are used in calculation of expression (7) or (13) in the recognizing process. Alternatively, at voting, f1 about the reference image may be used also as f2. In that case, a difference in focal length caused by zooming can be corrected by using expression (14) when the position is finally calculated.

$$( \begin{matrix}\begin{matrix}Δ {X}^{′} \\ Δ {Y}^{′}\end{matrix} \\ Δ {Z}^{′}\end{matrix} ) ≡ \frac{\sqrt{{s}_{1}}}{\sqrt{{S}_{12}}} ( \begin{matrix}\begin{matrix}Δ X \\ Δ Y\end{matrix} \\ Δ Z\end{matrix} ) = \frac{\sqrt{{s}_{1}}}{\sqrt{{s}_{2}}} ( \begin{matrix}\begin{matrix}{x}_{2} \\ {y}_{2}\end{matrix} \\ {f}_{1}\end{matrix} ) - R ( \begin{matrix}\begin{matrix}{x}_{1} \\ {y}_{1}\end{matrix} \\ {f}_{1}\end{matrix} ) + \frac{\sqrt{{s}_{1}}}{\sqrt{{s}_{2}}} ( \begin{matrix}0 \\ 0 \\ {f}_{2} - {f}_{1}\end{matrix} ) \qquad ( 14 )$$

The image processing apparatus shown in FIG. 1 is used for a robot, for example. In that case, it is possible that the robot moves after recognizing a model in the above-described manner and the image of a subject to be recognized becomes large or small on an input image, so that the model cannot appropriately be recognized on the input image. For this reason, the image processing apparatus performs zooming out by one step when the image of the subject in the input image can be seen with a predetermined large size or more and performs zooming in by one step when the image of the subject in the input image can be seen with a predetermined small size or less, so that the model in the input image can be appropriately recognized.

Now, a zooming process is described. First, a zoom out process is described.

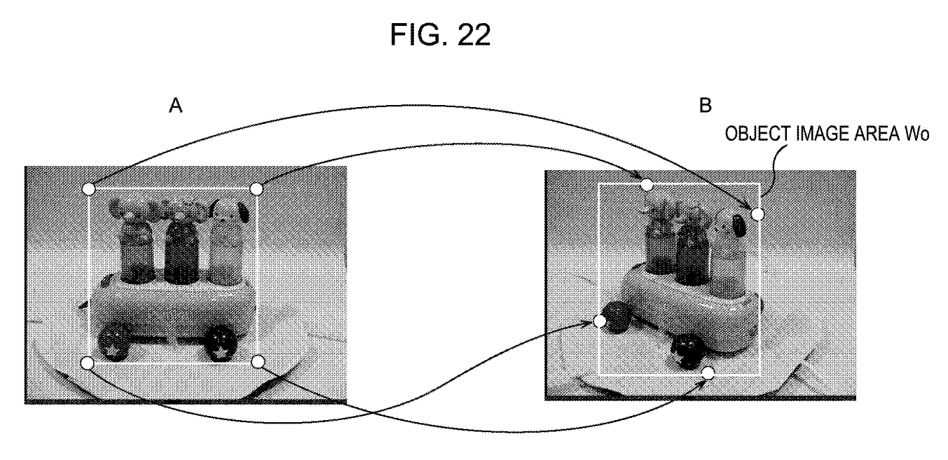

In a case where model recognition is performed in the above-described manner, the image processing unit 7 refers to the color area information in the model information of the recognized model in accordance with control by the control unit 9, and defines an area including the entire image of the model on the reference image as shown in A in FIG. 22 (area defined by the white frame). In this example, the color area information includes an x coordinate largest on the x axis of the color area, a y coordinate largest on the y axis, an x coordinate smallest on the x axis, and a y coordinate smallest on the y axis, which are the largest and smallest positions. The image processing unit 7 defines the area including the entire image of the model on the basis of the largest and smallest positions of each color area.

The image processing unit 7 transforms the area including the entire image of the model by using the rotation matrix R and the translation vector Δ at recognition of the model, as shown in B in FIG. 22, and defines the range as an object image area Wo.

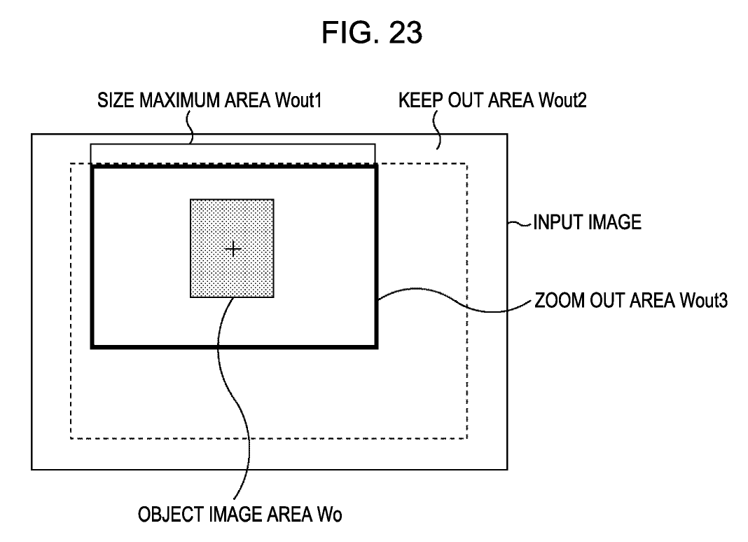

Then, as shown in FIG. 23, the image processing unit 7 sets the area having a size of about 0.6 to 0.7 times the input image, the center of the area being the center of the object image area Wo (indicated by a cross in FIG. 23), as a size maximum area Wout1 (the area defined by the solid-line frame). Also, the image processing unit 7 sets the area of about 5% to 20% of the lengths in the vertical and horizontal directions of the input image from edges of the input image (area between the edges of the input image and a broken-line frame) as a keep out area Wout2. Furthermore, the image processing unit 7 sets the area in the size maximum area Wout1 except the keep out area Wout2 as a zoom out area Wout3 (the area defined by the bold-line frame).

The image processing unit 7 determines whether the object image area Wo lies off the zoom out area Wout3. If determining that the area Wo lies off the area Wout3, the image processing unit 7 notifies the control unit 9 of the fact. Accordingly, the control unit 9 controls the lens driver 2 via the camera controller 8 so as to drive the zoom lens 1A and to perform zoom out so that the object image area Wo is placed within the zoom out area Wout3. Discrete zooming is performed, in which a zoom factor is set in about 0.57× steps, and the horizontal angle of view is 120, 90, 60, or 37 degrees.

Hereinafter, a zoom in process is described.

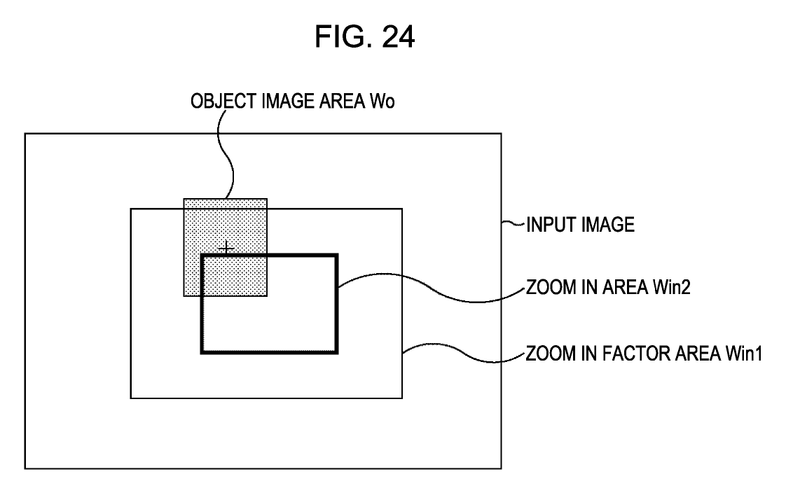

As shown in FIG. 24, the image processing unit 7 sets a zoom in factor area Win1 (area defined by the solid-line frame) within which the image is placed when being zoomed in, the center of the input image being its center. This is an area of the size of the zoom factor of the present image.

The image processing unit 7 sets a zoom in area Win2 (area defined by the bold-line frame), which is 0.5 times the zoom in factor area Win1, with the center being the center of the input image, so that the object image area Wo is placed in the zoom in factor area Win1.

The image processing unit 7 determines whether the object image area Wo is placed in the zoom in area Win2. If determining that the object image area Wo is placed in the zoom in area Win2 (if the object image area Wo is sufficiently small to be placed in the zoom in area Win2), the image processing unit 7 notifies the control unit 9 of the fact. Accordingly, the control unit 9 controls the lens driver 2 via the camera controller 8 so as to drive the zoom lens 1A and to perform zoom in so that the object image area Wo is placed in the zoom in factor area Win1.

When the size of the zoom out area Wou3 at zoom out is approximate to the size of the zoom in area Win2 at zoom in, chattering may occur just after zooming. In order to obtain hysteresis in zoom in and zoom out directions, the sizes of the both areas may differ from each other by a predetermined value or more.

Zooming is performed in the above-described manner. When a zooming command is transmitted to the lens driver 2, time delay occurs due to propagation of information. Thus, there is a possibility that a frame just after the command is transmitted is captured under a zoom condition before change (there is a possibility that the image stored in the memory 6 to be recognized in the image processing unit 7 is captured at an angle of view before zooming). At that time, if the above-described recognizing process is performed on the input image under a changed zoom condition (if the recognizing process is performed by using the focal length f2 at the zooming), the model is not appropriately recognized.

As countermeasures against this problem, zoom information including a horizontal angle of view specified by the control unit 9 can be written on an image captured by the camera module. Specifically, the zoom information is input to the camera signal processing unit 5, where the zoom information at capturing of the input image is written at the lower left corner of the input image.

The image processing unit 7 performs the above-described recognizing process by using the focal length f2 corresponding to the zoom information written on the image.

In this way, zoom information at image capturing is written on each input image, and model recognition is performed on the basis of the written zoom information, so that model recognition can be appropriately performed even if a zoom factor is changed.

The above-described series of processes can be performed by hardware or software. When the series of processes are performed by software, a program constituting the software is installed into a multi-purpose computer or the like.

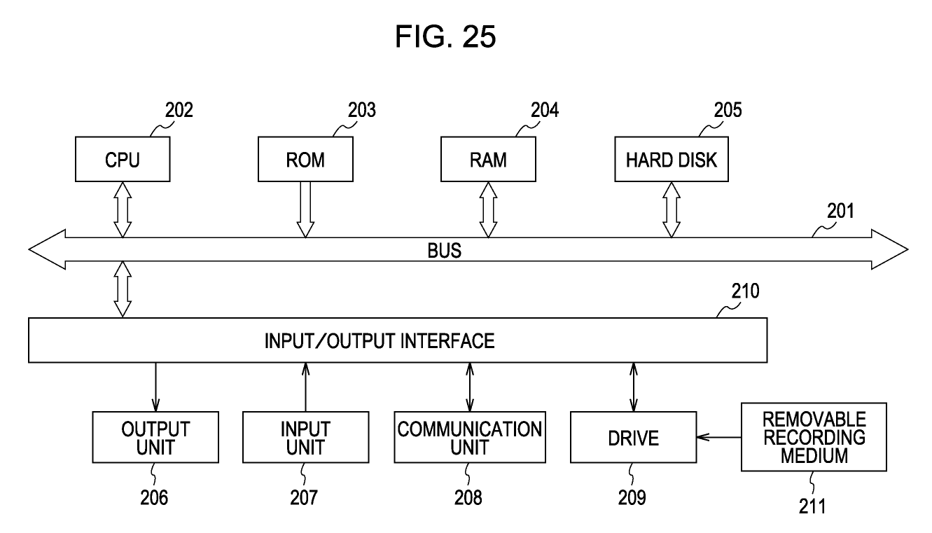

FIG. 25 shows an example of a configuration of a computer to which the program executing the above-described series of processes is installed.

The program can be recorded in advance in a recording medium included in the computer, such as a hard disk 205 or a ROM (read only memory) 203.

Alternatively, the program can be temporarily or permanently stored (recorded) on a removable recording medium 211, such as a flexible disk, a CD-ROM (compact disc read only memory), an MO (magneto-optical) disc, a DVD (digital versatile disc), a magnetic disk, or a semiconductor memory. The removable recording medium 211 can be provided as a so-called package software.

The program can be installed into the computer via the above-described removable recording medium 211. Alternatively, the program can be wirelessly transferred to the computer from a download site via an artificial satellite for digital satellite broadcast or can be transferred to the computer via a LAN (local area network) or the Internet in a wired manner. The computer can receive the transferred program by a communication unit 208 and install the program in the hard disk 205.

The computer includes a CPU (central processing unit) 202. The CPU 202 connects to an input/output interface 210 via a bus 201. When a user operates an input unit 207 including a keyboard, a mouse, and a microphone, a command issued by the operation is transmitted to the CPU 202 via the input/output interface 210 and the CPU 202 executes the program stored in the ROM 203 according to the command. Alternatively, the CPU 202 executes the program stored in the hard disk 205, the program transferred from the satellite or the network, received by the communication unit 208, and installed into the hard disk 205, or the program read from the removable recording medium 211 loaded in the drive 209 and installed into the hard disk 205, by loading the program to a RAM (random access memory) 204.

Accordingly, the CPU 202 executes the processes performed by the above-described configuration shown in the block diagram. Then, the CPU 202 outputs the processing result from an output unit 206 including an LCD (liquid crystal display) and a speaker via the input/output interface 210, or transmits the result from the communication unit 208, or records the result in the hard disk 205 as necessary.

The program may be processed by a computer or may be processed by a plurality of computers in a distributed manner. Furthermore, the program may be executed after being transferred to a remote computer.

The present invention is not limited to the above-described embodiments, but various modifications, combinations, sub-combinations and alterations may occur depending on design requirements and other factors insofar as they are within the scope of the appended claims or the equivalents thereof.

What is claimed is:

1. An image processing apparatus to recognize a predetermined model whose surface has a plurality of colors from an input color image that is obtained by capturing an image of a color object whose surface has a plurality of colors, the image processing apparatus comprising:
detecting means for detecting color areas from the input color image, each color area including adjoining pixels of the same color; and
recognizing means for determining whether the color areas on the input color image detected by the detecting means correspond to parts of the model to which color areas on a reference color image obtained by capturing an image of the model correspond, and determining whether the color object in the input color image is the model on the basis of the determination result.

2. The image processing apparatus according to claim 1,
wherein the recognizing means detects pairs of color area on the reference color image and color area on the input color image that can correspond to the same part of the model, determines whether the number of the pairs of color area on the reference color image and color area on the input color image that can be transformed in attitude by the same attitude parameter is a predetermined number or more, and determines whether the color object in the input color image is the model on the basis of the determination result.

3. The image processing apparatus according to claim 2, wherein the attitude parameter is a rotation matrix or translation.

4. The image processing apparatus according to claim 2, wherein the predetermined number corresponds to the number of color areas on the reference color image.

5. The image processing apparatus according to claim 2, wherein the recognizing means detects the position of the color object in the input color image on the basis of the attitude parameter after determining that the color object in the input color image is the model.

6. The image processing apparatus according to claim 2, wherein the recognizing means regards the color area on the reference color image and the color area on the input color image having the same color or a predetermined difference in aspect ratio as the pair that can correspond to the same part of the model.

7. The image processing apparatus according to claim 2, wherein the recognizing means performs vote for an attitude space of transform parameters used in attitude transform between the color area on the reference color image and the color area on the input color image in each of the pairs, determines whether the number of the pairs in which attitude transform between the color area on the reference color image and the color area on the input color image can be performed with the transform parameter corresponding to the largest votes is a predetermined number or more, and determines whether the color object in the input color image is the model on the basis of the determination result.

8. An image processing method for recognizing a predetermined model whose surface has a plurality of colors from an input color image that is obtained by capturing an image of a color object whose surface has a plurality of colors, the image processing method comprising the steps of:
detecting color areas from the input color image, each color area including adjoining pixels of the same color; and
determining whether the color areas on the input color image detected in the detecting step correspond to parts of the model to which color areas on a reference color image obtained by capturing an image of the model correspond, and determining whether the color object in the input color image is the model on the basis of the determination result.

9. A program allowing a computer to execute image processing of recognizing a predetermined model whose surface has a plurality of colors from an input color image that is obtained by capturing an image of a color object whose surface has a plurality of colors, the program comprising the steps of:
detecting color areas from the input color image, each color area including adjoining pixels of the same color; and
determining whether the color areas on the input color image detected in the detecting step correspond to parts of the model to which color areas on a reference color image obtained by capturing an image of the model correspond, and determining whether the color object in the input color image is the model on the basis of the determination result.

10. An image processing apparatus to recognize a predetermined model whose surface has a plurality of colors from an input color image that is obtained by capturing an image of a color object whose surface has a plurality of colors, the image processing apparatus comprising:
a detecting unit configured to detect color areas from the input color image, each color area including adjoining pixels of the same color; and
a recognizing unit configured to determine whether the color areas on the input color image detected by the detecting unit correspond to parts of the model to which color areas on a reference color image obtained by capturing an image of the model correspond, and determine whether the color object in the input color image is the model on the basis of the determination result.
